(19) United States
(12) Patent Application Publication
(10) Pub. No.: US 2022/0366876 A1
(43) Pub. Date: Nov. 17, 2022

(54) Mute for a Stringed Instrument

(71) Applicant: Abraham Lopez, Keller, TX (US)

(72) Inventor: Abraham Lopez, Keller, TX (US)

(21) Appl. No.: 17/321,148

(22) Filed: May 14, 2021

(51) Int. Cl. G10D 3/046; G10D 1/08

(52) U.S. Cl. CPC G10D 3/046; G10D 1/08

(57) ABSTRACT

A mute for a stringed instrument includes a muting material. The muting material includes a plurality of string-receiving recess portions extending substantially parallel to one another and into the muting material. The plurality of string-receiving recess portions is operable to receive a plurality of adjacent strings of the stringed instrument and the plurality of adjacent strings may be configured to be spaced apart from each other at variable widths. The muting material may include a grasping portion.

### CROSS-REFERENCE TO RELATED APPLICATIONS

The present application claims the benefit of, and priority to, U.S. Provisional Patent Application No. ______, filed via U.S. Mail on Apr. 20, 2021 and entitled MUTE FOR GUITAR, the disclosure of which is hereby incorporated by reference herein.

### TECHNICAL FIELD

The present disclosure relates generally to a mute for a stringed instrument operable to reduce the sound level of the stringed instrument.

### BACKGROUND

People play stringed instruments such as guitars, but certain environments or scenarios may bring limitations to the desired amount of volume that players of stringed instruments want their instruments to produce. Mutes for stringed instruments are directed to reducing sound levels (e.g. loudness) of stringed instruments. Traditional mutes may desirably affect the volume, while also interfering with the pitch and tone of stringed instruments. Additionally, certain stringed instruments may be highly expensive. However, traditional mutes for stringed instruments often contact surfaces of these highly expensive stringed instruments. Similarly, players of stringed instruments may use the ball or other region of a hand to reduce the volume of a stringed instrument instead of using a mute for a stringed instrument, resulting in physical contact with these highly expensive stringed instruments.

### SUMMARY

The present disclosure relates to a mute for a stringed instrument. In some implementations, the mute includes a muting material and a plurality of string-receiving recess portions extending substantially parallel to one another and into the muting material. In some implementations, the string-receiving recess portions receive adjacent strings of the stringed instrument and the adjacent strings may be spaced apart from each other at variable widths. In some implementations, the muting material may include a grasping portion. In various implementations, the muting material consists essentially of rubber, or plastic, or foam. In some implementations, the muting material may be substantially rectangular.

In some implementations, a mute for a stringed instrument may include a muting material having a width spanning adjacent strings of the stringed instrument wherein the muting material consists essentially of lesser density rubber composites. The muting material may include a first plurality of spaced apart slotted recess portions extending substantially vertically into the muting material and a second plurality of spaced apart slotted recess portions extending substantially horizontally into the muting material. In some implementations, each of the first plurality of spaced apart slotted recess portions intersects a corresponding one of the second plurality of spaced apart slotted recess portions. In some implementations, the muting material has a grasping portion which allows for convenient grasping of the mute. The width of the muting material may be approximately 3.15 inches, the height of the muting material may be approximately 1 inch, and/or the depth of the muting material may be approximately 0.09 inches. In some implementations, the first plurality of spaced apart slotted recess portions extends substantially vertically into the muting material a distance of approximately 0.34 inches and/or the second plurality of spaced apart slotted recess portions extends substantially horizontally into the muting material a distance of approximately 0.18 inches.

In some implementations, a mute for a stringed instrument may include a muting material having a width spanning adjacent strings of a stringed instrument, and further including a coupling means for coupling the muting material to the adjacent strings, wherein the adjacent strings are configured to be spaced apart from each other at variable widths. In some implementations, when the coupling means couples the muting material to the adjacent strings, the muting material maintains its position in the direction across the adjacent strings. In some implementations, when the coupling means couples the muting material to the adjacent strings, the muting material maintains its position relative to a surface of the stringed instrument and, in some implementations, does not contact the surface of the stringed instrument. In some implementations, the muting material has a grasping portion allowing for convenient grasping of the muting material. In some implementations, the muting material consists essentially of rubber, or plastic, or foam.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 illustrates a perspective view of an implementation of a mute for a stringed instrument coupled to a guitar according to the present disclosure, depicting how the mute is positioned in one context of the entire guitar.

FIG. 2 illustrates a perspective view of an implementation of a mute for a stringed instrument according to the present disclosure.

FIG. 3 illustrates a side plan view of the mute for a stringed instrument of FIG. 2.

FIG. 4 illustrates an end plan view of the mute for a stringed instrument of FIG. 2.

FIG. 5 illustrates a perspective view of the mute for a stringed instrument of FIG. 2 coupled to strings of a stringed instrument.

FIG. 6 illustrates a perspective view of the mute for a stringed instrument of FIG. 2 coupled to strings of a guitar in a location on the strings of the guitar relative to the guitar where the mute for the stringed instrument of FIG. 2 may be placed according to the present disclosure. FIG. 6 also illustrates a placement range for the mute for a stringed instrument on the strings of the guitar relative to the guitar.

FIG. 7 illustrates a side plan view of FIG. 6.

FIG. 8 illustrates a perspective view of another implementation of a mute for a stringed instrument according to the present disclosure.

FIG. 9 illustrates a side plan view of the mute for a stringed instrument of FIG. 8.

FIG. 10 illustrates a perspective view of the mute for a stringed instrument of FIG. 8 coupled to strings of a stringed instrument.

FIG. 11 illustrates a perspective view of yet another implementation of a mute for a stringed instrument according to the present disclosure coupled to strings of a stringed instrument.

### DETAILED DESCRIPTION

Implementations of the present disclosure generally provide for a mute for a stringed instrument which includes a muting material and a plurality of string-receiving recess portions extending substantially parallel to one another and into the muting material. The plurality of string-receiving recess portions is operable to receive a plurality of adjacent strings of a stringed instrument. The plurality of adjacent strings may be configured to be spaced apart from each other at variable widths.

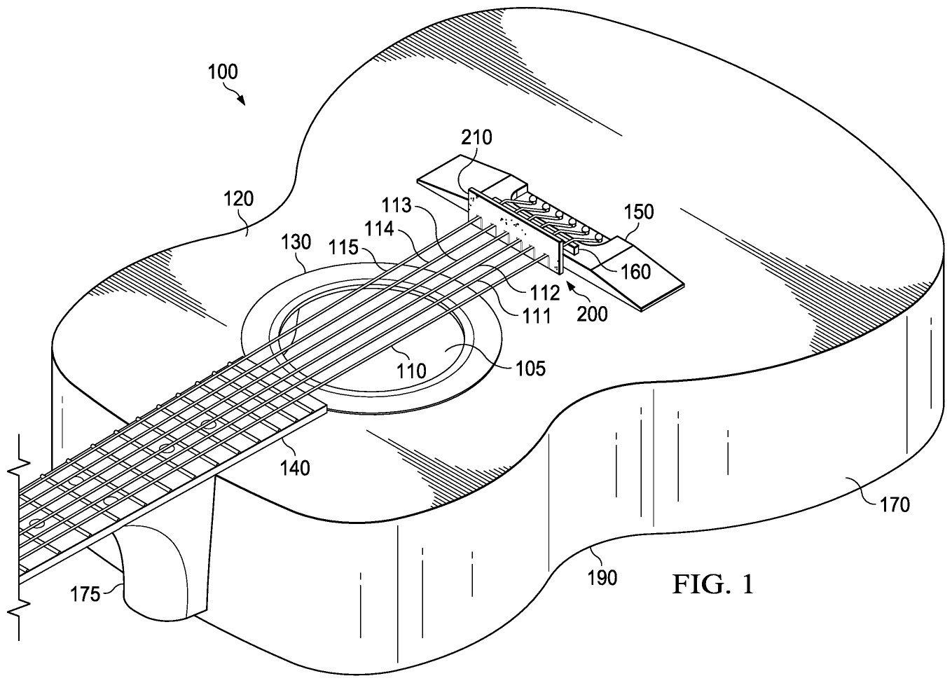

FIGS. 1-11 depict various implementations of mutes for stringed instruments, each mute comprising a muting material and a plurality of string-receiving recess portions extending substantially parallel to one another and into said muting material. Representative but non-limiting examples of a stringed instrument 100 include guitar, classical guitar, acoustic guitar, electro-acoustic guitar, semi-acoustic guitar, electric guitar, bass guitar, ukulele, violin, viola, cello, double bass, harp, banjo, or mandolin.

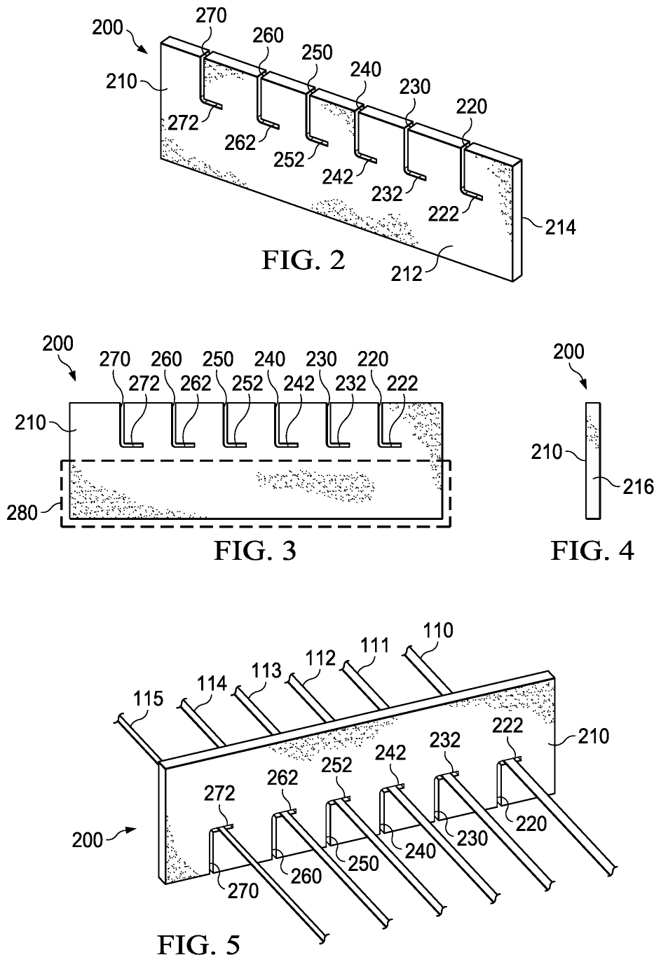

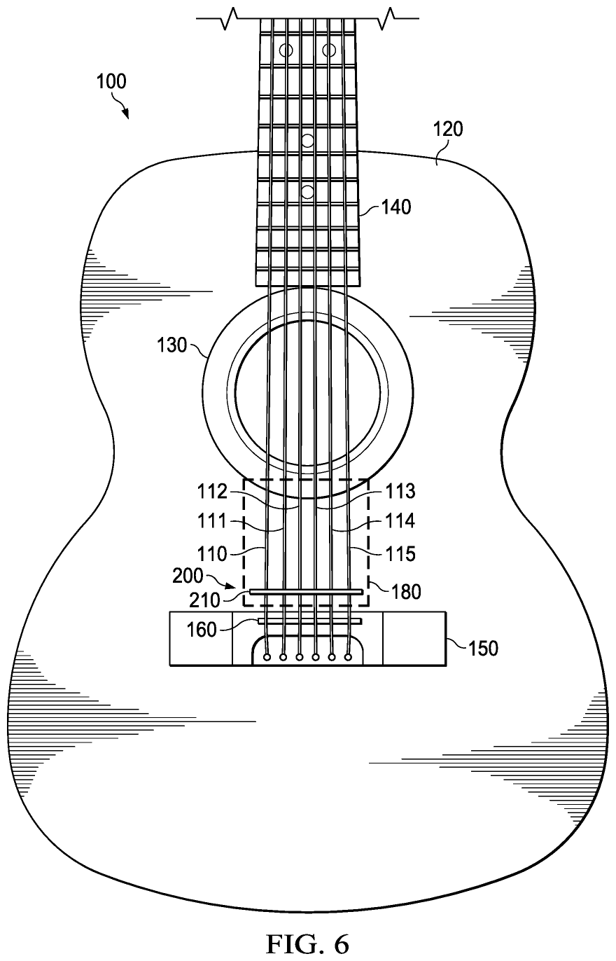

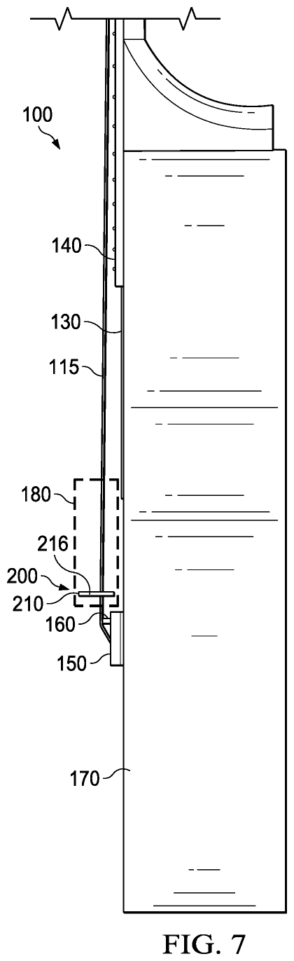

FIGS. 1-7 illustrate various views of an implementation of a mute 200 for a stringed instrument, according to the present disclosure. In particular, FIG. 1 illustrates a perspective view of said mute 200 coupled to a stringed instrument 100 according to the present disclosure and shows how said mute 200 is positioned in one context of said stringed instrument 100; FIGS. 2, 3 and 4 illustrate a perspective view, a side plan view, and an end plan view, respectively, of said mute 200 for a stringed instrument; FIG. 5 illustrates said mute 200 coupled to six strings 110, 111, 112, 113, 114, 115 of a stringed instrument 100; FIG. 6 illustrates said mute 200 coupled in a location on said strings 110, 111, 112, 113, 114, 115 relative to said stringed instrument 100 where said mute 200 may be placed; FIG. 6 also illustrates a placement range 180 for said mute 200 relative to said stringed instrument 100; and FIG. 7 illustrates a side plan view of the stringed instrument 100 depicted in FIG. 6.

FIG. 1 illustrates a perspective view of said mute 200 coupled to a stringed instrument 100 and shows how said mute 200 may be positioned in one context of said stringed instrument 100. In more detail, stringed instrument 100 comprises a hollow body 105, the body 105 including a top surface 120, a side surface 170, and a bottom surface 190. A sound hole 130 may be formed in said top surface 120, said sound hole 130 extending into said hollow body 105, and a bridge 150 may be coupled to said top surface 120 below said sound hole 130. Said stringed instrument 100 may further comprise a saddle 160 coupled to said bridge 150. Said stringed instrument 100 may further comprise a fretboard 140 coupled to said top surface 120 and coupled via a support 175 to said side surface 170. The fretboard 140 may extend beyond said hollow body 105. Strings 110, 111, 112, 113, 114, 115 of said stringed instrument 100 may be coupled at one end to said bridge 150; may further rest on said saddle 160; may further extend across and over said sound hole 130; may further extend along said fretboard 140; may further rest on a guitar nut (not shown); and may further extend to be coupled at an opposite end to one or more tuning machines (not shown).

FIG. 2 illustrates a perspective view of an implementation of said mute 200 for a stringed instrument comprising a muting material 210, which may be formed in a substantially rectangular shape. Said muting material 210 may consist essentially of various sound dampening materials such as, but not limited to, lesser density rubber composites, mousepad material, Y37 foam, Ethylene-vinyl acetate (EVA) foam, V44 foam, cross-linked polyethylene foam, closed-cell foam, Irradiated Cross-linked Polyethylene foam, or plastic. In some implementations, said muting material 210 is formed of mousepad material comprising a fabric material, such as but not limited to a polyester fabric or a microfiber fabric, coupled to either a lesser density rubber composite, including but not limited to an open-cell styrene, a butadiene rubber, an open-cell rubber or an open-cell styrene-butadiene rubber (SBR), or to a neoprene rubber. In some implementations, said muting material 210 is formed of mousepad material comprising a micro-woven cloth material, such as but not limited to a micro-woven polyester cloth or a micro-woven microfiber cloth, coupled to a rubber composite comprising 100 percent natural rubber and a raising agent. In some implementations, said rubber composite may further comprise silicon.

Said muting material 210 comprises a front surface 212 and a back surface 214. In some implementations, said front surface 212 and said back surface 214 have substantially the same dimensions. In some implementations, said muting material 210 may have a width operable to span a plurality of adjacent strings of a stringed instrument. In some implementations, said muting material 210 may have a width of approximately 3.15 inches. In some implementations, said muting material 210 may have a width operable to span one string of a stringed instrument.

Said mute 200 for a stringed instrument may further comprise a plurality of substantially L-shaped string-receiving recess portions. In more detail, said mute 200 may comprise a first plurality of string-receiving recess portions 220, 230, 240, 250, 260, 270 extending substantially parallel to one another and into said muting material 210. Each of said first plurality of string-receiving recess portions 220, 230, 240, 250, 260, 270 cuts across said muting material 210 from said front surface 212 to said back surface 214 allowing for said string receiving recess portions 220, 230, 240, 250, 260, 270 to receive strings for a stringed instrument. In some implementations, said first plurality of string-receiving recess portions 220, 230, 240, 250, 260, 270 extends substantially vertically into said muting material 210 a distance of approximately 0.34 inches. Said mute 200 for a stringed instrument may further comprise a second plurality of string-receiving recess portions 222, 232, 242, 252, 262, 272 extending substantially horizontally into said muting material 210. Each of said first plurality of string-receiving recess portions 220, 230, 240, 250, 260, 270 intersects a corresponding one of said second plurality of string-receiving recess portions 222, 232, 242, 252, 262, 272 to form the substantially L-shaped string-receiving recess portions. In some implementations, said second plurality of string-receiving recess portions 222, 232, 242, 252, 262, 272 extends substantially horizontally into said muting material 210 a distance of approximately 0.18 inches. In some implementations, said first plurality of string-receiving recess portions 220, 230, 240, 250, 260, 270 and/or said second plurality of string-receiving recess portions 222, 232, 242, 252, 262, 272 may be formed by cutting said muting material 210. In some implementations, said first plurality of string-receiving recess portions 220, 230, 240, 250, 260, 270 and/or said second plurality of string-receiving recess portions 222, 232, 242, 252, 262, 272 may be formed through a prefabricated process such as 3D-printing or foam production. In some implementations, said first plurality of string-receiving recess portions 220, 230, 240, 250, 260, 270 may be equally spaced apart from one another such that they match the spacing of adjacent strings of a stringed instrument. In some implementations, said muting material 210 may have a height of approximately 1 inch.

FIG. 3 illustrates a side plan view of said mute 200 for a stringed instrument. As depicted in FIG. 3, said muting material 210 may further comprise a grasping portion 280. Said grasping portion 280 is located in a region of said muting material 210 outside the area where said first plurality of string-receiving recess portions 220, 230, 240, 250, 260, 270 and said second plurality of string-receiving recess portions 222, 232, 242, 252, 262, 272 extend. Said grasping portion 280 allows for convenient grasping of said muting material 210 by a musician or user of said mute 200 to allow for movement along the direction of the strings of the stringed instrument while in use in order to change the effectiveness of said mute 200 for a stringed instrument. Effectiveness of said mute 200 for a stringed instrument may be measured in terms of how the volume, pitch, or tone of the stringed instrument is changed.

FIG. 4 illustrates an end plan view of said mute 200 wherein said muting material 210 may comprise a side surface 216. The depth of said side surface 216 can impact the sound dampening properties of said mute 200 for a stringed instrument. In some implementations, said muting material 210 may have a depth of approximately 0.09 inches. Said side surface 216 may also allow for convenient grasping of said mute 200 for a stringed instrument by the musician or user.

FIG. 5 illustrates a perspective view of said mute 200 coupled to six strings 110, 111, 112, 113, 114, 115 of a stringed instrument. As depicted in FIG. 5, each of said first plurality of string-receiving recess portions 220, 230, 240, 250, 260, 270 intersects a corresponding one of said second plurality of string-receiving recess portions 222, 232, 242, 252, 262, 272. To couple said strings 110, 111, 112, 113, 114, 115 to said mute 200, a user of said mute 200 may first slide said strings 110, 111, 112, 113, 114, 115 into each of said first plurality of string-receiving recess portions 220, 230, 240, 250, 260, 270. In some circumstances, however, strings 110, 111, 112, 113, 114, 115 may be spaced apart from each other at various widths depending on the preference of the user or musician of the stringed instrument. In that circumstance, a user of said mute 200 may then slide said strings 110, 111, 112, 113, 114, 115 into each of said second plurality of string-receiving recess portions 222, 232, 242, 252, 262, 272. Because said second plurality of string-receiving recess portions 222, 232, 242, 252, 262, 272 extend substantially horizontally into said muting material 210, said strings 110, 111, 112, 113, 114, 115 are allowed to be spaced apart from each other at the user's desire, allowing for finetuning of the instrument.

In some circumstances, a user or musician may wish to have a stronger and more secure coupling of said mute 200 to said strings 110, 111, 112, 113, 114, 115 in order to prevent said mute 200 from falling off of the stringed instrument or contacting surfaces of the stringed instrument. In that circumstance, a user of said mute 200 may then slide said strings 110, 111, 112, 113, 114, 115 into each of said second plurality of string-receiving recess portions 222, 232, 242, 252, 262, 272. Because said second plurality of string-receiving recess portions 222, 232, 242, 252, 262, 272 extend substantially horizontally into said muting material 210 said strings 110, 111, 112, 113, 114, 115 are better kept in place and inhibited from moving up and down vertically while a user plays the stringed instrument. Even though said strings 110, 111, 112, 113, 114, 115 are better kept in place when coupled to said second plurality of string-receiving recess portions 222, 232, 242, 252, 262, 272, said second plurality of string-receiving recess portions 222, 232, 242, 252, 262, 272 maintain their muting and sound dampening properties.

FIG. 6 illustrates a perspective view of said mute 200 coupled in a location on said strings 110, 111, 112, 113, 114, 115 relative to said stringed instrument 100 where said mute 200 may be placed. FIG. 6 also illustrates a placement range 180 for said mute 200 coupled to said strings 110, 111, 112, 113, 114, 115. As illustrated in FIG. 6, said placement range 180 may lie between a saddle 160 coupled to a bridge 150 and a sound hole 130. In some circumstances, a stringed instrument 100 may not comprise a sound hole 130, and in those circumstances, where said stringed instrument 100 may comprise a fretboard 140 coupled to a top surface 120, a placement range 180 may lie between a saddle 160 coupled to a bridge 150 and said fretboard 140.

FIG. 7 illustrates a side plan view of FIG. 6. In more detail, FIG. 7 illustrates said placement range 180 for said mute 200 coupled to said string 115. As illustrated in FIG. 7, said placement range 180 may lie between a saddle 160 coupled to a bridge 150 and a sound hole 130. In some circumstances, a stringed instrument 100 may not comprise a sound hole 130, and in those circumstances, where said stringed instrument 100 may comprise a fretboard 140 coupled to a top surface 120, a placement range 180 may lie between a saddle 160 coupled to a bridge 150 and said fretboard 140. In further detail, FIG. 7 illustrates that said placement range 180 is vertically positioned above a top surface 120 and a side surface 170. When said mute 200 is coupled to said string 115 said mute 200 does not contact said top surface 120 or said side surface 170. Moreover, when said mute 200 is coupled to said string 115 said mute 200 does not necessarily contact said saddle 160, bridge 150, fretboard 140, or said sound hole 130. In more detail, a side surface 216 of muting material 210 may only be long enough such that when said mute 200 is coupled to said string 115 of a stringed instrument 100 said mute 200 does not contact said top surface 120. Because said mute 200 does not contact said top surface 120 and said mute 200 does not necessarily contact said saddle 160, bridge 150, fretboard 140, or said sound hole 130, said mute 200 does not damage said stringed instrument 100 while coupled to it. This is advantageous because many other mutes for stringed instruments contact surfaces of their respective stringed instruments during use, thus potentially damaging these highly expensive instruments and costing a user of these mutes repair fees.

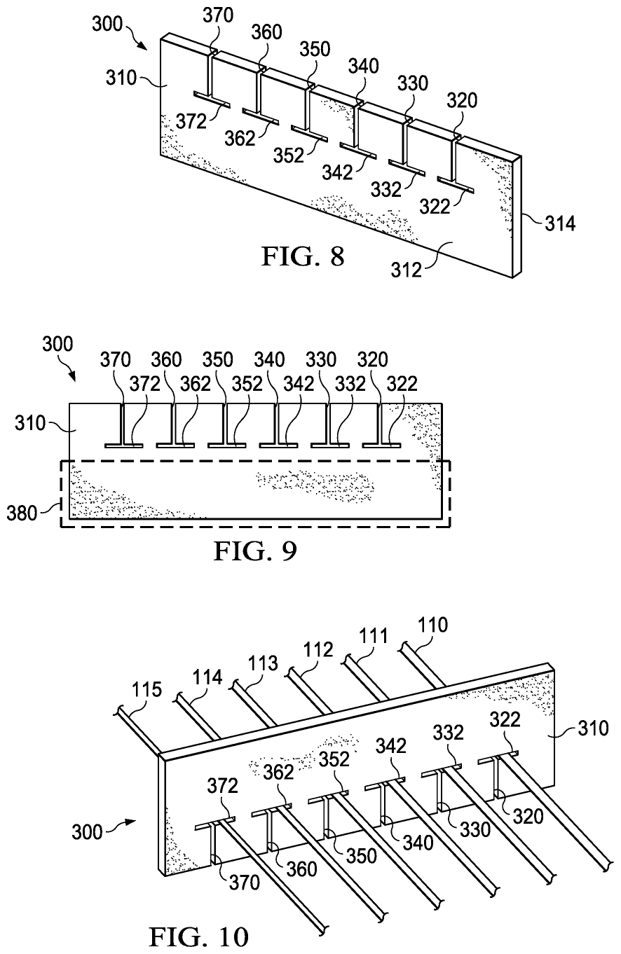

FIGS. 8-10 illustrate various views of another implementation of a mute 300 for a stringed instrument, according to the present disclosure. In particular, FIG. 8 illustrates a perspective view of said mute 300; FIG. 9 illustrates a side plan view of said mute 300; and FIG. 10 illustrates said mute 300 coupled to strings 110, 111, 112, 113, 114, 115 of a stringed instrument 100.

FIG. 8 illustrates a perspective view of an implementation of said mute 300 comprising a muting material 310, which may be formed in a substantially rectangular shape. Said muting material 310 may consist essentially of various sound dampening materials such as, but not limited to, lesser density rubber composites, mousepad material, Y37 foam, Ethylene-vinyl acetate (EVA) foam, V44 foam, cross-linked polyethylene foam, closed-cell foam, Irradiated Cross-linked Polyethylene foam, or plastic. In some implementations, said muting material 310 is formed of mousepad material comprising a fabric material, such as but not limited to a polyester fabric or a microfiber fabric, coupled to either a lesser density rubber composite, including but not limited to an open-cell styrene, a butadiene rubber, an open-cell rubber or an open-cell styrene-butadiene rubber (SBR), or to a neoprene rubber. In some implementations, said muting material 310 is formed of mousepad material comprising a micro-woven cloth material, such as but not limited to a micro-woven polyester cloth or a micro-woven microfiber cloth, coupled to a rubber composite comprising 100 percent natural rubber and a raising agent. In some implementations, said rubber composite may further comprise silicon.

Said muting material 310 comprises a front surface 312 and a back surface 314. In some implementations, said muting material 310 may have a width operable to span a plurality of adjacent strings of a stringed instrument. In some implementations, said muting material 310 may have a width of approximately 3.15 inches. In some implementations, said muting material 310 may have a width operable to span one string of a stringed instrument.

Said mute 300 for a stringed instrument may further comprise a plurality of substantially T-shaped string-receiving recess portions. In more detail, said mute 300 may comprise a first plurality of string-receiving recess portions 320, 330, 340, 350, 360, 370 extending substantially parallel to one another and into said muting material 310. Each of said first plurality of string-receiving recess portions 320, 330, 340, 350, 360, 370 cuts across said muting material 310 from said front surface 312 to said back surface 314 allowing for said string receiving recess portions 320, 330, 340, 350, 360, 370 to receive strings for a stringed instrument. In some implementations, said first plurality of string-receiving recess portions 320, 330, 340, 350, 360, 370 extends substantially vertically into said muting material 310 a distance of approximately 0.34 inches. Said mute 300 for a stringed instrument may further comprise a second plurality of string-receiving recess portions 322, 332, 342, 352, 362, 372 extending substantially horizontally into said muting material 310. Each of said first plurality of string-receiving recess portions 320, 330, 340, 350, 360, 370 intersects a corresponding one of said second plurality of string-receiving recess portions 322, 332, 342, 352, 362, 372 to form the substantially T-shaped string-receiving recess portions. In some implementations, said second plurality of string-receiving recess portions 322, 332, 342, 352, 362, 372 extends substantially horizontally into said muting material 310 a distance of approximately 0.36 inches. In some implementations, said first plurality of string-receiving recess portions 320, 330, 340, 350, 360, 370 and/or said second plurality of string-receiving recess portions 322, 332, 342, 352, 362, 372 may be formed by cutting said muting material 310. In some implementations, said first plurality of string-receiving recess portions 320, 330, 340, 350, 360, 370 and/or said second plurality of string-receiving recess portions 322, 332, 342, 352, 362, 372 may be formed through a prefabricated process such as 3D-printing or foam production. In some implementations, said first plurality of string-receiving recess portions 320, 330, 340, 350, 360, 370 may be equally spaced apart from one another such that they match the spacing of adjacent strings of a stringed instrument. In some implementations, said muting material 310 may have a height of approximately 1 inch.

FIG. 9 illustrates a side plan view of said mute 300 for a stringed instrument. As depicted in FIG. 9, said muting material 310 may further comprise a grasping portion 380. Said grasping portion 380 is located in a region of said muting material 310 outside the area where said first plurality of string-receiving recess portions 320, 330, 340, 350, 360, 370 and said second plurality of string-receiving recess portions 322, 332, 342, 352, 362, 372 extend. Said grasping portion 380 allows for convenient grasping of said muting material 310 by a musician or user of said mute 300 to allow for movement along the direction of the strings of the stringed instrument while in use in order to change the effectiveness of said mute 300. Effectiveness of said mute 300 for a stringed instrument may be measured in terms of how the volume, pitch, or tone of the stringed instrument is changed.

FIG. 10 illustrates a perspective view of said mute 300 coupled to six strings 110, 111, 112, 113, 114, 115 of a stringed instrument. As depicted in FIG. 10, each of said first plurality of string-receiving recess portions 320, 330, 340, 350, 360, 370 intersects a corresponding one of said second plurality of string-receiving recess portions 322, 332, 342, 352, 362, 372. To couple said strings 110, 111, 112, 113, 114, 115 to said mute 300, a user of said mute 300 may first slide said strings 110, 111, 112, 113, 114, 115 into each of said first plurality of string-receiving recess portions 320, 330, 340, 350, 360, 370. In some circumstances, however, strings 110, 111, 112, 113, 114, 115 may be spaced apart from each other at various widths depending on the preference of the user or musician of the stringed instrument. In that circumstance, a user of said mute 300 may then slide said strings 110, 111, 112, 113, 114, 115 into each of said second plurality of string-receiving recess portions 322, 332, 342, 352, 362, 372. Because said second plurality of string-receiving recess portions 322, 332, 342, 352, 362, 372 extend substantially horizontally into said muting material 310, said strings 110, 111, 112, 113, 114, 115 are allowed to be spaced apart from each other at the user's desire allowing for finetuning of the instrument.

In some circumstances, a user or musician may wish to have a stronger and more secure coupling of said mute 300 to said strings 110, 111, 112, 113, 114, 115 in order to prevent said mute 300 from falling off of the stringed instrument or contacting surfaces of the stringed instrument. In that circumstance, a user of said mute 300 may then slide said strings 110, 111, 112, 113, 114, 115 into each of said second plurality of string-receiving recess portions 322, 332, 342, 352, 362, 372. Because said second plurality of string-receiving recess portions 322, 332, 342, 352, 362, 372 extend substantially horizontally into said muting material 310 said strings 110, 111, 112, 113, 114, 115 are better kept in place and inhibited from moving up and down vertically while a user plays the stringed instrument. Even though said strings 110, 111, 112, 113, 114, 115 are better kept in place when coupled to said second plurality of string-receiving recess portions 322, 332, 342, 352, 362, 372, said second plurality of string-receiving recess portions 322, 332, 342, 352, 362, 372 maintain their muting and sound dampening properties.

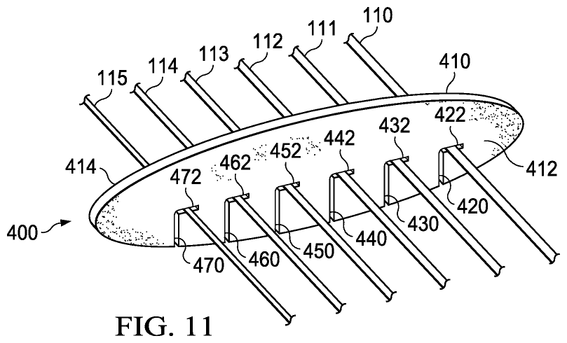

FIG. 11 illustrates a perspective view of yet another implementation of a mute 400 for a stringed instrument, according to the present disclosure, which may be formed in a substantially oval shape. Said mute 400 comprises a muting material 410. Said muting material 410 may consist essentially of various sound dampening materials such as, but not limited to, lesser density rubber composites, mousepad material, Y37 foam, Ethylene-vinyl acetate (EVA) foam, V44 foam, cross-linked polyethylene foam, closed-cell foam, Irradiated Cross-linked Polyethylene foam, or plastic. In some implementations, said muting material 410 is formed of mousepad material comprising a fabric material, such as but not limited to a polyester fabric or a microfiber fabric, coupled to either a lesser density rubber composite, including but not limited to an open-cell styrene, a butadiene rubber, an open-cell rubber or an open-cell styrene-butadiene rubber (SBR), or to a neoprene rubber. In some implementations, said muting material 410 is formed of mousepad material comprising a micro-woven cloth material, such as but not limited to a micro-woven polyester cloth or a micro-woven microfiber cloth, coupled to a rubber composite comprising 100 percent natural rubber and a raising agent. In some implementations, said rubber composite may further comprise silicon.

Said muting material 410 comprises a front surface 412 and a back surface 414. In some implementations, said muting material 410 may have a width operable to span a plurality of adjacent strings of a stringed instrument. In some implementations, said muting material 410 may have a width of approximately 3.15 inches. In some implementations, said muting material 410 may have a width operable to span one string of a stringed instrument.

Said mute 400 may further comprise a plurality of substantially L-shaped string-receiving recess portions. In more detail, said mute 400 may comprise a first plurality of string-receiving recess portions 420, 430, 440, 450, 460, 470 extending substantially parallel to one another and into said muting material 410. Each of said first plurality of string-receiving recess portions 420, 430, 440, 450, 460, 470 cuts across said muting material 410 from said front surface 412 to said back surface 414 allowing for said string receiving recess portions 420, 430, 440, 450, 460, 470 to receive strings for a stringed instrument. In some implementations, said first plurality of string-receiving recess portions 420, 430, 440, 450, 460, 470 extends substantially vertically into said muting material 410 a distance of approximately 0.34 inches. Said mute 400 may further comprise a second plurality of string-receiving recess portions 422, 432, 442, 452, 462, 472 extending substantially horizontally into said muting material 410. Each of said first plurality of string-receiving recess portions 420, 430, 440, 450, 460, 470 intersects a corresponding one of said second plurality of string-receiving recess portions 422, 432, 442, 452, 462, 472 to form the substantially L-shaped string-receiving recess portions. In some implementations, said second plurality of string-receiving recess portions 422, 432, 442, 452, 462, 472 extends substantially horizontally into said muting material 410 a distance of approximately 0.18 inches. In some implementations, said first plurality of string-receiving recess portions 420, 430, 440, 450, 460, 470 and/or said second plurality of string-receiving recess portions 422, 432, 442, 452, 462, 472 may be formed by cutting said muting material 410. In some implementations, said first plurality of string-receiving recess portions 420, 430, 440, 450, 460, 470 and/or said second plurality of string-receiving recess portions 422, 432, 442, 452, 462, 472 may be formed through a prefabricated process such as 3D-printing or foam production. In some implementations, said first plurality of string-receiving recess portions 420, 430, 440, 450, 460, 470 may be equally spaced apart from one another such that they match the spacing of adjacent strings of a stringed instrument. In some implementations, said muting material 410 may have a height of approximately 1 inch.

FIG. 11 further illustrates a perspective view of said mute 400 coupled to said strings 110, 111, 112, 113, 114, 115. As depicted in FIG. 11, each of said first plurality of string-receiving recess portions 420, 430, 440, 450, 460, 470 intersects a corresponding one of said second plurality of string-receiving recess portions 422, 432, 442, 452, 462, 472. To couple said strings 110, 111, 112, 113, 114, 115 to said mute 400, a user of said mute 400 may first slide said strings 110, 111, 112, 113, 114, 115 into each of said first plurality of string-receiving recess portions 420, 430, 440, 450, 460, 470. In some circumstances, however, strings 110, 111, 112, 113, 114, 115 may be spaced apart from each other at various widths depending on the preference of the user or musician of the stringed instrument. In that circumstance, a user of said mute 400 may then slide said strings 110, 111, 112, 113, 114, 115 into each of said second plurality of string-receiving recess portions 422, 432, 442, 452, 462, 472. Because said second plurality of string-receiving recess portions 422, 432, 442, 452, 462, 472 extend substantially horizontally into said muting material 410, said strings 110, 111, 112, 113, 114, 115 are allowed to be spaced apart from each other at the user's desire allowing for finetuning of the instrument.

In some circumstances, a user or musician may wish to have a stronger and more secure coupling of said mute 400 to said strings 110, 111, 112, 113, 114, 115 in order to prevent said mute 400 from falling off of the stringed instrument or contacting surfaces of the stringed instrument. In that circumstance, a user of said mute 400 may then slide said strings 110, 111, 112, 113, 114, 115 into each of said second plurality of string-receiving recess portions 422, 432, 442, 452, 462, 472. Because said second plurality of string-receiving recess portions 422, 432, 442, 452, 462, 472 extend substantially horizontally into said muting material 410 said strings 110, 111, 112, 113, 114, 115 are better kept in place and inhibited from moving up and down vertically while a user plays the stringed instrument. Even though said strings 110, 111, 112, 113, 114, 115 are better kept in place when coupled to said second plurality of string-receiving recess portions 422, 432, 442, 452, 462, 472, said second plurality of string-receiving recess portions 422, 432, 442, 452, 462, 472 maintain their muting and sound dampening properties.

### Experimental Results

An experiment was done to quantitatively demonstrate the ability of an implementation of a mute of the present disclosure to reduce volume and maintain pitch of a stringed instrument. It was ultimately found that the experimental implementation of a mute of the present disclosure decreased the time-weighted loudness of the guitar by 330%, while still yielding an audible pitch.

The experimental mute of the present disclosure was formed of a mousepad muting material with a front surface, a back surface, a side surface, and six string-receiving recess portions extending substantially parallel to one another and into the muting material. In particular, the experimental mute was made from the mousepad material of the SteelSeries QcK+Cloth Gaming Mouse Pad manufactured by SteelSeries ApS of Denmark and available through steelseries.com. The muting material had a width of approximately 3.15 inches, which was operable to span six strings of the guitar, and the muting material had a depth of approximately 0.09 inches. The muting material had a substantially rectangular shape with substantially L-shaped string receiving recess portions.

There were two main dependent variables measured in this experiment: volume and pitch maintenance. Volume is defined as the psychoacoustic perception of sound pressure/loudness, in this case measured in decibels (dB). Every musical note has a sound envelope, which is the transient effect of the note over time. In the context of playing stringed instruments, attack refers to how long it takes sound to start and to reach its peak volume after a string is struck. In the context of playing stringed instruments, sustain refers to the endurance of a string's vibration. For a guitar, the sound envelope peaks with the attack and quickly decays (relative to other instruments). Still, since the sustain of a guitar can last for many seconds, it is necessary to understand the effect of the volume over the entire length of the sustain. Thus, the raw data for volume can be numerically integrated over time measured in seconds (to yield a unit of dB·s) to get time-weighted loudness—a better metric for comparison to the unmuted volume over time.

In the context of stringed instruments, pitch is defined as the quality that allows a listener to classify a sound as relatively high or low. Specifically, pitch is measured in terms of its frequency, and in this experiment, pitch was measured in hertz. Pitch maintenance is defined as the ability to maintain a pitch (in this case, measured in Hertz (Hz)) over the sustain. The lowest pitch of any stringed instrument is called a fundamental. The fundamental may be created by vibration over the full length of a string. The fundamental is a harmonic. A harmonic is any member of the harmonic series, an ideal set of frequencies that are positive integer multiples of a common fundamental. A fundamental is also considered a harmonic is because it is 1 times itself. Overtones are other sinusoidal components present at frequencies above the fundamental. All of the frequency components that make up the total waveform, including the fundamental and the overtones, are called partials. When a musical note is played, one hears the fundamental along with a series of partials (the harmonic series). Generally, the more partials present, the higher the note quality, so the number of partials was also a metric for comparison to the unmuted pitch.

### Experimental Procedure

Data for two cases was taken: the first case was a control (no mute) and the second case was with an experimental mute of the present disclosure applied. In the second case, the experimental mute was placed 1 inch from the saddle of the guitar. The below methods were repeated for both cases.

First, data for the time-weighted loudness of the guitar was taken. In this case, a constant orthogonal distance of 52 inches from the top surface of the guitar to the measurement device (a phone using the app “Decibel X”) was kept. A first-string pluck was recorded, as well as a single strum of all strings, both for five trials. Data from Decibel X was then turned into a CSV (Comma-Separated Values) file for further analysis. A CSV file is a delimited text file that uses a comma to separate values. Each line of the file is a data record. Each record consists of one or more fields, separated by commas. A CSV file can be easily imported into spreadsheet software for statistical analysis of the data contained in the CSV file.

Then, data for the pitch and partials was taken. The measurement device for this was a computer tablet (using the app “TonalEnergy Tuner and Metronome”) positioned orthogonally to the soundboard of the guitar and a few inches away. Because pitch does not vary with distance, the distance from the guitar was not measured or controlled. The first string of the guitar was plucked, and the value for the pitch and the number of partials was recorded for five trials.

### Experimental Data

TABLE 1
Raw Data for First Case (Control)

| | Pluck | Strum | | |
|---|---|---|---|---|
| | Loudness | Loudness | Pitch | Max # |
| Trial | (dB · s) | (dB · s) | (Hz) | of partials |
| 1 | 206.2 | 325.3 | 330 | 9 |
| 2 | 185.5 | 383.6 | 330 | 11 |
| 3 | 237.7 | 309.9 | 330 | 8 |
| 4 | 210.2 | 340.6 | 330 | 8 |
| 5 | 212.8 | 322.9 | 330 | 8 |

TABLE 2
Raw Data for Second Case (with Mute)

| | Pluck | Strum | | |
|---|---|---|---|---|
| | Loudness | Loudness | Pitch | Max # |
| Trial | (dB · s) | (dB · s) | (Hz) | of partials |
| 1 | 36.07 | 83.78 | 335 | 5 |
| 2 | 39.00 | 80.10 | 331 | 7 |
| 3 | 36.52 | 79.60 | 330 | 3 |
| 4 | 51.85 | 78.95 | 326 | 5 |
| 5 | 54.43 | 86.13 | 330 | 7 |

TABLE 3
Averaged Data

| | Pluck | Strum | | |
|---|---|---|---|---|
| | Loudness | Loudness | Pitch | Max # |
| | (dB · s) | (dB · s) | (Hz) | of partials |
| First Case | 210.5 | 336.5 | 330.0 | 8.8 |
| Control | | | | |
| Second Case | 43.57 | 81.71 | 330.4 | 5.4 |
| With Mute | | | | |

### Experimental Results Conclusion

Considering the above results, it appears that the mute of the present disclosure performs as expected in all categories. In terms of time-weighted loudness (which is volume integrated with respect to time), the guitar with the mute was over 330% (percent change) quieter than the control. This is because the mute both decreases the attack and the sustain of the notes. Although the mute also altered the measured pitch, the measured difference is both qualitatively and quantitatively negligible, meaning the pitch is still audible. Finally, the guitar with the mute had less partials than the control, but this is to be expected when muffling the sound of the guitar.

It is to be understood the implementations of mutes for stringed instruments of the present disclosure are not limited to particular systems or processes described which may, of course, vary. It is also to be understood that the terminology used herein is for the purpose of describing particular implementations only and is not intended to be limiting. As used in this specification, the singular forms “a”, “an” and “the” include plural referents unless the content clearly indicates otherwise. As another example, “coupling” includes direct and/or indirect coupling of members.

Although the present disclosure has described various implementations of a mute for a stringed instrument in detail, it should be understood that various changes substitutions may be made herein without departing from the spirit and scope of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding implementations described herein may be utilized according to the present disclosure. Accordingly, the appended claims are intended to include within their scope such processes machines, manufacture, compositions of matter, means, methods, or steps.

1. A mute for a stringed instrument, comprising:
a muting material having a width operable to span a plurality of adjacent strings of said stringed instrument;
said muting material consisting essentially of lesser density rubber composites;
a first plurality of spaced apart slotted recess portions extending substantially vertically into said muting material; and
a second plurality of spaced apart slotted recess portions extending substantially horizontally into said muting material;
wherein each of said first plurality of spaced apart slotted recess portions intersects a corresponding one of said second plurality of spaced apart slotted recess portions.

2. The mute according to claim 1, wherein:
said muting material having a grasping portion operable to allow for convenient grasping of said mute.

3. The mute according to claim 1, wherein:
said width of said muting material is approximately 3.15 inches.

4. The mute according to claim 1, wherein:
said muting material having a height of approximately 1 inch; and
said muting material having a depth of approximately 0.09 inches.

5. The mute according to claim 1, wherein:
said first plurality of spaced apart slotted recess portions extends substantially vertically into said muting material a distance of approximately 0.34 inches.

6. The mute according to claim 1, wherein:
said second plurality of spaced apart slotted recess portions extends substantially horizontally into said muting material a distance of approximately 0.18 inches.

7. A mute for a stringed instrument, comprising:
a muting material; and
a first plurality of string-receiving recess portions extending substantially parallel to one another and into said muting material, wherein said first plurality of string-receiving recess portions is operable to receive a plurality of adjacent strings of said stringed instrument and is configured to be spaced apart from each other at variable widths; and
a second plurality of string-receiving recess portions extending substantially parallel to one another into said muting material, wherein each of said second plurality of string-receiving recess portions intersects a corresponding one of said first plurality of string-receiving recess portions and is operable to receive a string from one of said first plurality of string-receiving recess portions.

8. The mute according to claim 7, wherein:
said muting material consists essentially of rubber.

9. The mute according to claim 7, wherein:
said muting material consists essentially of plastic.

10. The mute according to claim 7, wherein:
said muting material consists essentially of foam.

11. The mute according to claim 7, wherein:
said muting material is substantially rectangular.

12. The mute according to claim 7, wherein:
said muting material having a grasping portion operable to allow for convenient grasping of said mute.

13. A mute for a stringed instrument, comprising:
a muting material having a width operable to span a plurality of adjacent strings of said stringed instrument; and
a coupling means for coupling said muting material to said plurality of adjacent strings;
wherein said plurality of adjacent strings is configured to be spaced apart from each other at variable widths;
wherein said coupling means is comprised of a first and a second recessed portion and said recessed portions extend into said muting material and intersect with each other.

14. The mute according to claim 13, wherein:
when said coupling means couples said muting material to said plurality of adjacent strings, said muting material maintains its position in the direction across said plurality of adjacent strings.

15. The mute according to claim 13, wherein:
when said coupling means couples said muting material to said plurality of adjacent strings, said muting material maintains its position relative to a surface of said stringed instrument.

16. The mute according to claim 15, wherein:
when said coupling means couples said muting material to said plurality of adjacent strings, said muting material does not contact said surface of said stringed instrument.

17. The mute according to claim 16, wherein:
said muting material having a grasping portion adjacent said coupling means is operable to allow for convenient grasping of said mute.

18. The mute according to claim 13, wherein:
said muting material consists essentially of rubber.

19. The mute according to claim 13, wherein:
said muting material consists essentially of plastic.

20. The mute according to claim 13, wherein:
said muting material consists essentially of foam.
